(19) United States
(12) Patent Application Publication
(10) Pub. No.: US 2016/0287014 A1
(43) Pub. Date: Oct. 6, 2016

(54) Electric toaster with ceramic heating plates

(71) Applicant: Raymond Floyd, Cody, WY (US)

(72) Inventor: Raymond Floyd, Cody, WY (US)

(73) Assignee: Raymond Floyd, Cody, WY (US)

(21) Appl. No.: 14/676,979

(22) Filed: Apr. 2, 2015

(51) Int. Cl. A47J 37/08

(52) U.S. Cl. CPC A47J 37/08; A47J 37/0814

(57) ABSTRACT

An electric toaster/heater assembly wherein the housing defines at least one toasting chamber for slices of bread or other goods. In current technology, toasting chambers are lined with heat elements, typically resistance wires, spaced some distance apart. Said toasting elements provide radiation to toast the item inserted into the chambers. In the proposed application, the toasting chamber will consist of ceramic panels heated via internally contained resistive wire elements which will provide even radiation to toast the items inserted into the chamber.

### FIELD OF THE INVENTION

This invention relates to an electric toasting assembly, and toasters in general, used to provide heating or browning of bread, rolls, bagels, and similar edible commodities.

### BACKGROUND OF THE INVENTION

Presently known toasters include a first group wherein the toasting chamber has an inlet, or inlets, for admission of commodities to be treated and such inlet(s) also serves as an outlet for treated goods. These toasters are typically provided with a means for automatically expelling toasted commodities, such that they may be grasped by hand. The toasters of the second group, most often found in commercial applications, have a toasting chamber with an inlet for admission of the goods to be toasted, and a discrete outlet for evacuation of the freshly toasted goods. This second group of toasters will typically evacuate the toasted items by means of a gravity feed.

The heating elements of presently known toasters are electric resistance wire heaters which emit heat when connected in a circuit with a source of electrical energy. There are two drawbacks for such an arrangement. First, the spacing of the wires is critical in the evenness of the toasting of the commodity. Second, when using the toaster for a single slice of toast, both heating chambers are activated, thus using energy that is wasted in the open chamber.

### SUMMARY OF THE INVENTION

An object of the invention is to provide an electric toaster whose toasting action provides a more uniform and predictable outcome than that of conventional toasters.

Another object of the invention is to provide a means of applying heat to a single chamber when only a single slice of toast is desired.

The improved toaster can be used to heat and brown slices of bread and/or other goods and comprises a housing which defines a chamber for goods to be toasted. The toaster further comprises a means for heating the goods in the chamber, where such heating is from ceramic plates embedded with heating elements, thus providing an even heat for the toasting action.

The improved toaster will also contain solid-state switches which are activated by sensor switches in each inlet slot when an item is detected in the toasting position. Otherwise, the non-active toasting slot will not be powered on as a heating action.

### BRIEF DESCRIPTION OF DRAWINGS

FIG. 1 is an illustration of a two slot toaster.

FIG. 2 is an illustration of the ceramic assemblies on the inside of the toaster.

FIG. 3 is an illustration of the ceramic assemblies including the heating wires and the solid-state switch assembly.

### DETAILED DESCRIPTION OF THE PREFERRED EMBODIMENT

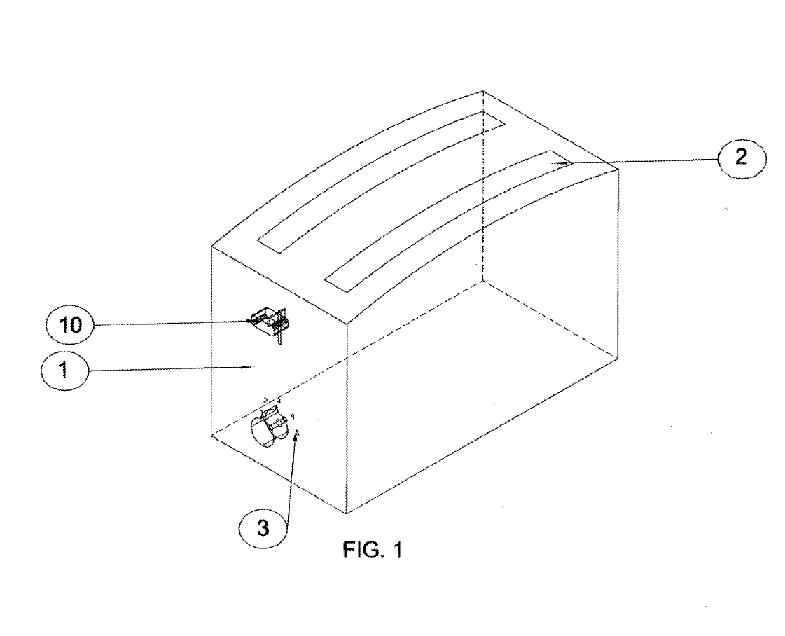

FIG. 1 is the preferred embodiment of the invention, being a two-slot electric toaster 1. The toaster may be expanded in the number of slots available, with the most common numbers being two or four for home use. The slots 2 are the inlet and outlet slots in the toaster. The toaster will typically have a push down handle 10, which is pushed down when the commodity to be toasted has been placed into one or more slots 2. The toaster will typically have an adjustment setting 3 which allows the user to select the degree of brownness or heating desired of the commodity inserted.

When the desired value is met, the toaster will automatically turn off and elevate the commodity being heated to a position that will allow the commodity to be removed from the toaster.

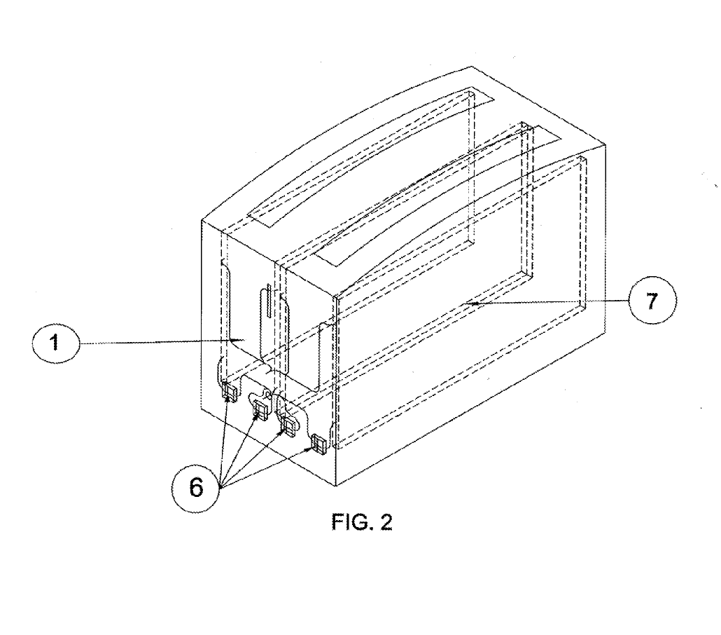

FIG. 2 provides an interior view of the electric toaster 1. Internal to the toaster 1 are a set of ceramic plates 7. Each plate 7 consists of two parts, a cover facing into the toast slot and a slotted ceramic sheet that houses the heating element. In the preferred embodiment, there are two ceramic plate sets 7 found within each toaster slot, one to either side of the slot. Each ceramic plate set interfaces to a solid state switch 6, which activates the electrical circuit if a commodity is detected in the slot.

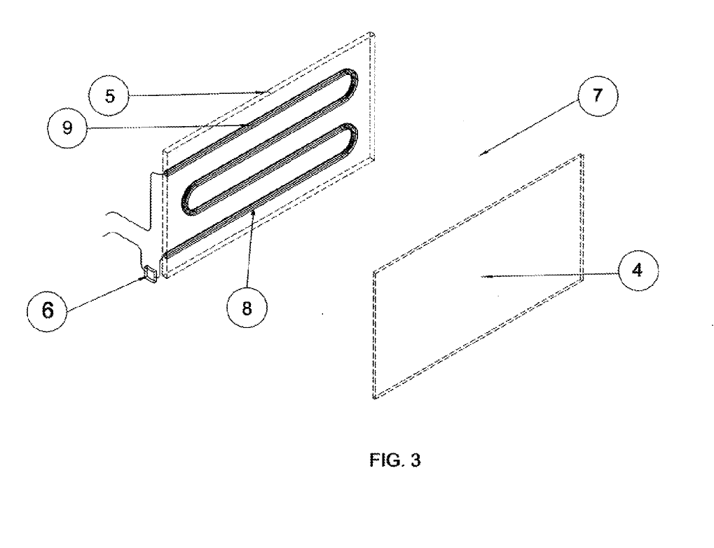

FIG. 3 provides an illustration of the ceramic plate 7 construction in the preferred embodiment. The ceramic plate set 7 consists of two ceramic plates joined together. The ceramic plate 4 that faces the toasting slot has a smooth surface to radiate heat into the toasting cavity. The second ceramic plate 5 consists of a number of slots 9 which traverse the face of the ceramic plate 5. Within the slots 9 will be the heating element 8. The heating element 8 will be energized via the solid-state switch 6 if there is a commodity detected within the toaster slot. The solid-state switch 6 will be energized if the commodity presence detect micro-switch mounted on the commodity support is closed. The support and micro-switch are not illustrated.

1. An electric toaster which consists of:
a housing,
one or more slots for food insertion, and
ceramic plates as heating elements.

2. The toaster of claim 1 wherein the ceramic plates consist of two ceramic plates.

3. The toaster of claim 1 wherein one ceramic plate is grooved such as to accept resistive heating wire elements.

4. The toaster of claim 3 wherein the two ceramic plates, with one having resistive heating wire inserted, are joined together to form a heating element.

5. The toaster of claim 3 wherein a ceramic heating element is inserted on either side of the food insertion slot.
